(19) United States
(12) Patent Application Publication
(10) Pub. No.: US 2021/0153455 A1
(43) Pub. Date: May 27, 2021

(54) LIVESTOCK FEEDER

(71) Applicant: BARNTOOLS, LLC, West Des Moines, IA (US)

(72) Inventor: Lloyd D. Snell, Ames, IA (US)

(21) Appl. No.: 17/093,935

(22) Filed: Nov. 10, 2020

Related U.S. Application Data
(60) Provisional application No. 62/938,731, filed on Nov. 21, 2019.

(51) Int. Cl. A01K 5/02; A01K 7/02

(52) U.S. Cl. CPC A01K 5/0225; A01K 7/025

(57) ABSTRACT

A livestock feeding system comprising a feed tank reservoir, the feed tank reservoir having first and second end panels opposite and parallel to each other and first and second side panels opposite and parallel to each other, the side panels and end panels connected to form a generally rectangular structure for holding animal feed. A feed shelf adjuster mounts to at least one side panel and connects to an adjustable feed shelf. One or more divider panels create individual feeding stalls. Exposed edges of the feeding system components include longitudinally extending double folded safety edges to prevent injury to feeding animals.

### CROSS REFERENCE TO RELATED APPLICATIONS

This patent application claims priority to U.S. Provisional Patent Application No. 62/938,731 filed on Nov. 21, 2019, the entirety of which is incorporated herein fully by reference.

### FIELD OF THE DISCLOSURE

This disclosure pertains to an animal feeder, and in particular pertains to an improved wet-dry animal feeder that prevents animal injury and withstands the stresses typically encountered by a feeder used in a livestock operation.

### BACKGROUND OF THE DISCLOSURE

The wet-dry feeder art requires improvements for the swine production industry to address continued deficiencies in structural failure, feed leakage, feed shelf adjuster robustness and animal health and well-being.

Current feeders frequently experience structural failures that include failures of divider panels, feed shelf spans, and feed pan connections to the floor. More specifically, the divider panels used to create feed stalls and reduce conflict between adjacent animals during feeding are failing due to bending and joint failure both due to design and assembly methods. Ultimately, the animal feed stall needs structural improvements to maintain the integrity of the individual feeding spaces and increase animal well-being by minimizing conflicts between animals.

Feed shelf spans often fail due to deflection and yielding due to failure to apply simple engineering principles such as load transfer, use of existing structural elements, and constraining components to increase robustness. For example, many existing feeders feature an adjustment mechanism that is connected to the feed shelf with a flat plate connecting strap. The strap is then connected to the flat surface of the feed shelf. This loading places a moment on the connecting strap and results in flexing and bending of both the shelf and the strap. Bent shelves and straps reduce the ability to control the feed rate. The flat surface of the feed shelf is weakest part of the shelf profile for transferring the shelf loading. Loading is created by the feed or the animal's interaction with the feeder, and in situations where the feed and animal are both placing loads on the flat surface of the feed shelf, failure can occur. Finally, the connecting strap which parallels the end panel surface is subject of the unique failures caused by feed trapped between the two paralleling surfaces. These failures include inaccurate positioning or total inoperability.

Feeders secured to the floor with the addition of a bolt down plate are flexing and failing. The addition of an external bolt down plate interferes with the installation of pen gating.

Feed leakage often occurs around the shelf that separates the feed supply tank from the feed pan where the animal eats from. In addition, failure of the adjustment mechanism to maintain a feed supply rate results in uncontrolled feed delivery and wasted feed. In feeders that use a mechanical shelf adjustment, failure results in a fully open state and uncontrolled delivery of feed. In the worst case, the feed overflows the pan and enters the bio-waste system, thus reducing feed efficiency.

A typical wet-dry feeder is typically manufactured of 300-grade stainless steel. The manufacturing process includes cutting, bending, and the welding the parts and sub-assemblies together. Current construction techniques rely on the welding of unintentional combination and cost reduction forms to provide strength and well-being at joints and along spans.

Historical feeder art falls into these general subgroups: assembly methods; internal agitation systems; fixed feed surfaces that are relatively parallel to the side panel feed gates; adjustable feed shelves that perform as the feed gates; flat strap connection between shelf and adjustment mechanism; threaded, lever-linkage, and friction adjustment mechanisms; and dry or wet-dry feeders.

Mayo (U.S. Pat. No. 3,035,545) teaches an assembly method utilizing a complex series of bends and interlocking panels, and is a non-economical solution. Animal well-being is an important consideration for any livestock feeder, and the non-continuous bends featured in the Mayo feeder expose sharp edges exposed that can cause cut injuries to animals that can result in infection and death.

Pannier (U.S. Pat. No. 4,351,274) and Kingery (U.S. Pat. No. 4,315,484) teach systems for minimizing clogging due to feed bridging. With the move to indoor production, proper angle of repose and the use of low coefficient of friction materials such as stainless steel this requirement is not utilized in modern feeders.

Tolley (U.S. Pat. No. 2,834,320), Van Dusseldorp (U.S. Pat. No. 4,278,049), Herring (U.S. Pat. No. 4,306,518), Kingery (U.S. Pat. No. 4,315,484), Pannier (U.S. Pat. No. 4,351,274), Schwieger (U.S. Pat. No. 4,377,130), Petersen (U.S. Pat. No. 4,385,591), Bohlmann (U.S. Pat. No. 4,444,151), Herring, Sr. (U.S. Pat. No. 4,491,087), King (U.S. Pat. No. 5,036,798), Evans, III et al. (U.S. Pat. No. 5,345,894), Kleinsasser (U.S. Pat. No. 5,640,926), Bondarenko et al. (U.S. Pat. No. 5,921,200), Pollock et al. (U.S. Pat. No. 6,253,705), Lato (U.S. Pat. No. 8,459,204), and Adermann (U.S. Pat. No. 8,800,491) all teach a feed flow control solution utilizing vertical feed gates that are generally parallel to the angle of repose of the side panel. The feed gates typically have guides on each end and are connected to a positioning mechanism located remotely and in proximity of the top of the feed bin. When the vertical feed gates are raised, creating an opening, feed flows from the tank into each feed stall or stationary shelf. This system does not promote the hog's instinct to root for food.

Kleinsasser (U.S. Pat. No. 4,660,508), King (U.S. Pat. No. 4,911,727), Kleinsasser (U.S. Pat. No. 5,010,849), Hofer et al. (U.S. Pat. No. 5,595,139), and Jansen et al. (U.S. Pat. No. 9,313,999) teach a positional feed shelf typically controlled by a control mechanism located in proximity of the top of the feed bin at each end. The feed shelf spans the width of the feeder and promotes the natural rooting instinct of the hog. This rooting causes feed to fall off the shelf into the feed stall and pan. The vertical feed gates and feed shelf position are controlled by fixed anchoring, threaded, lever-linkage and friction mechanisms.

Tolley (U.S. Pat. No. 2,834,320) discloses the most basic of the feed gate adjustment mechanism which utilizes bolt and nut to set the vertical feed gate or feed shelf position.

Van Dusseldorp (U.S. Pat. No. 4,278,049), Herring (U.S. Pat. No. 4,306,518), Schwieger (U.S. Pat. No. 4,377,130), Petersen (U.S. Pat. No. 4,385,591), Bohlmann (U.S. Pat. No. 4,444,151), Thibault (U.S. Pat. No. 4,462,338), Zumbahlen (U.S. Pat. No. 4,582,023), Kleinsasser (U.S. Pat. No. 4,660,508) King (U.S. Pat. No. 5,036,798), Wiwi (U.S. Pat. No. 5,069,164), Evans III et al. (U.S. Pat. No. 5,345,894), Waldner et al. (U.S. Pat. No. 5,570,656), Hofer et al. (U.S. Pat. No. 5,595,139), Kleinsasser (U.S. Pat. No. 5,603,285), Brisby (U.S. Pat. No. 5,606,934), Kleinsasser (U.S. Pat. No. 5,640,926), and Loewe (U.S. Pat. No. 7,036,455) all teach threaded adjustment mechanisms. All thread adjustment systems are time consuming methods for changing feed rates and are not representative of the current industry standard. This is due to the rate of adjustment of thread pitch, which is extremely slow and laborious. For instance, a two-inch movement in the vertical feed gate or feed shelf requires 16 revolutions with a thread pitch of eight. With some of the existing solutions there are two to four adjustment links, i.e., up to 64 revolutions needed to fully change a single feeder's settings.

Van Dusseldorp (U.S. Pat. No. 4,278,049), Bohlmann (U.S. Pat. No. 4,444,151), Zumbahlen (U.S. Pat. No. 4,582,023), Kleinsasser (U.S. Pat. No. 4,660,508), Hofer et al. (U.S. Pat. No. 5,595,139), Kleinsasser (U.S. Pat. No. 5,603,285), Brisby (U.S. Pat. No. 5,606,934), and Kleinsasser (U.S. Pat. No. 5,640,926) all disclose a variant of a rod that is long or short with a threaded section. The rod is constrained to allow only rotational movement. The rod's threaded section is inserted into a threaded sleeve, nut, or collar which is fixed to the feed adjustment gate via a flat strap or linkage connected to the vertical feed gate or feed shelf. Herring (U.S. Pat. No. 4,306,518) discloses a similar threaded rod solution, but the threads are inversely located to the top and a simple wing nut is used to make the adjustment. Petersen (U.S. Pat. No. 4,385,591) teaches a vertical threaded mechanism with a crank and components fundamentally similar to Herring and others but coupled to a feed adjustment mechanism which includes an animal actuated system to disturb the feed in the tank to prevent bridging. Thibault (U.S. Pat. No. 4,462,338) teaches another threaded solution that connects to a flexible member such as a rope, cable, or chain to lift a feed adjust gate. The gate's weight and feed apply the load through the flexible member. Evans III et al. (U.S. Pat. No. 5,345,894) and Waldner et al. (U.S. Pat. No. 5,570,656) teach simple locking methods to prevent unintended adjustment of threaded adjustment mechanisms. Finally, Loewe (U.S. Pat. No. 7,036,455) teaches a threaded adjustment mechanism that changes the relative position of the feed tank to the feed stall, thus increasing or decreasing the feed rate. The mechanism of Loewe does not provide an easy or practical method for high volume animal production.

Kingery (U.S. Pat. No. 4,315,484), Bondarenko et al. (U.S. Pat. No. 5,921,200), Rasmussen (U.S. Pat. No. 6,330,867), Kleinsasser (U.S. Pat. No. 6,923,142), Lato (U.S. Pat. No. 8,459,204), Adermann (U.S. Pat. No. 8,800,491), Kleinsasser (U.S. Pat. No. 8,939,109), and Jansen et al. (U.S. Pat. No. 9,313,999) all teach variations of lever and linkage adjustment mechanisms. All levers utilize a pivot point, a connection linkage between the lever and the vertical feed gate or feed shelf. The lever may utilize a locking system mechanically retaining the desired position. Kingery (U.S. Pat. No. 4,315,484) teaches a lever-linkage mechanism connected to a slide plate gating system. The L-shaped lever provides mechanical advantage and a positioning method located on one leg and the linkage is connect to the other leg. Bondarenko et al. (U.S. Pat. No. 5,921,200) teaches a lever-linkage system that has a spring-loaded latch pin that engages with holes in the end panel. To set a feed gate, the operator pulls the latch pin and moves the lever to the desired feed rate setting. Bondarenko's system has a pointer integrated in the lever which points to a scaled reference of vertical feed gate or feed shelf position. The feeder may have more than one lever-linkage system to fully adjust feeder output flow. The holes in the end plate for securing the latch pins may allow for feed leakage.

Kleinsasser (U.S. Pat. Nos. 6,923,142 and 8,939,109) teaches a lever-linkage system where a fine set of teeth are radially located a distance ‘r’ from the axis of rotation. The handle has a matching set of fine teeth that interlock with the radially located teeth. This interaction may require an operator to use two hands to deflect and hold the handle or a release latch in the deflected state during adjusting the vertical feed gate or feed shelf. A pair of intersecting slots, one in the mounting plate and one in the handle, guide a pin in the flat lifting strap to maintain the flat strap vertical and adjust the height position of the vertical feed gate or feed shelf. Lato (U.S. Pat. No. 8,459,204) teaches a multi lever-link system that utilizes interlocking tabs and slots in a handle and control plate. Unlike many other lever-linkage systems the handle movement is not parallel to the end panel. The lever still pivots about a bolt or pin and linkage is connected to the handle and the vertical feed gate or feed shelf. Adermann (U.S. Pat. No. 8,800,491) teaches a multitude of lever-linkage systems that provide multiple combinations of linking one control with a locking apertures method to control one or multiple vertical connection links to the vertical feed gate or feed shelf. Rasmussen (U.S. Pat. No. 6,330,867) discloses a lever-linkage and system also using a aperture locking control lever.

Jansen et al. (U.S. Pat. No. 9,313,999) teaches a friction mechanism that allows the operator to infinitely adjust the shelf position without first releasing and securing a mechanical lock after adjusting. The friction mechanism includes a floating fibrous disk material compressed between two steel structures. In simplified form, a central bolt is tightened to increase loading and the friction force to prevent rotation. Engineering principles teach that as the bolt loading increases, the plate becomes concaved and the normal force applied to friction material decreases radially from the bolt centerline axis. Alterations to the design to improve the expected performance includes a second bolt is added at a radius greater than the outer diameter of the friction material. Then the tightening of the axis bolt and radial bolt creates a linear compression zone between the two fasteners. This method is structurally detrimental to the floating friction material. This compression zone results in the friction material to experience a compression and tension duty cycle in zones mirrored about the compression zone. This repeated cycling results in catastrophic failure of the friction material resulting in lack of feed shelf position control. Loss of shelf control delivers too much feed to the animals and in the case of hog confinement applications feed waste into the bio waste holding pit below the floor. The fibrous disk material's coefficient of friction is affected by material finish and moisture further complicating the ability to repeatably set load values. Attempts have been made to increase the friction by blasting the material surface to increase roughness.

Many feeders, including Jansen et al. (U.S. Pat. No. 9,313,999) connect the adjuster mechanism and feed shelf with a flat strap parallel with the feeder end panel and a 90-degree bend installed and bolted underneath the feed shelf. The flat part of the strap is parallel with the feed bin end panel. The bend is located under the shelf top surface and bolted. The load of the feed acts on the shelf face causing the shelf to bend between the two end supports causing the straps to bow away from the tank end panel and results in feed becoming lodged between the two surfaces. Lodged feed results in the restriction of motion and decreasing the aperture opening, decreasing feed release. A design that prevents the lodging of food in the adjustment mechanism components is desired.

Feed stall divider in many feeders are just assumed and are not thoroughly engineered to withstand the long-term abuse from confined animals. For most disclosed feeders, the divided feed stall is just a simple bar as taught by King (U.S. Pat. No. 5,036,798). King's dividers do not prevent visual contact between animals and thus probably served as a tank support versus a solution to minimize feeding conflict and animal well-being. Thibault (U.S. Pat. No. 4,462,338), Barewald (U.S. Pat. No. 5,749,315), Lato (U.S. Pat. No. 8,459,204), and Kleinsasser (U.S. Pat. No. 8,939,109) all teach an extended feed stall divider panel. The divider typically begins in the feed pan, extends parallel to the feed tank and is connected to the tapered section of the feed tank. The feed stall divider panel is typically welded around the perimeter and on the exposed face has a safety hem. The safety hem may be a closed, open, tear drop or rolled form. This form provides well-being protection for the feeding animal and limited gains in lateral strength. Due to this limited structural gain, feed stall dividers are flexed back and forth by the animal resulting in fatigue and failure, most likely near a weld. Failure in this structure reduces the feeder efficiency and increase the likelihood of animal conflict during feeding.

Kleinsasser (U.S. Pat. No. 4,660,508) teaches the basic concept of a wet-dry feeder with a water system below a movable shelf, connected to an adjustment mechanism by a flat strap parallel to an end panel. Data has proven the wet-dry feeder to provide the greatest efficiency in calorie conversion.

Therefore, for all the reasons stated above and herein, there is a need in the art for an improved livestock confinement feeder.

Thus, it is the object of the disclosure to provide an improved confinement feeder that improves upon the state of the art.

Another object of the disclosure is a feeder in which all animal contact surfaces are structurally robust to withstand long-term high-volume animal contact.

Another object of the disclosure is to provide a feeder in which all animal contact surfaces are structurally robust, interconnected, and jointed in a manner to withstand long-term high-volume animal contact.

Another object of the disclosure is to ensure animal well-being by providing contact surfaces that are continuously smooth, thus preventing injury.

Another object of the disclosure is to provide a durable feed shelf adjuster mechanism.

Another object of the disclosure is to provide a feed shelf adjuster mechanism that is simple to operate.

Another object of the disclosure is to provide a feed shelf adjuster mechanism that is operable with a single hand.

Another object of the disclosure is to provide a feed shelf adjuster mechanism adjustable by discrete increments.

Another object of the disclosure is to provide a feed shelf adjuster mechanism that can be remotely controlled.

Another object of the disclosure is to provide a simple to manufacture high volume feed shelf adjuster mechanism.

Another object of the disclosure is to provide a feed shelf adjuster mechanism that is simple to install.

Another object of the disclosure is to provide a feed shelf adjuster mechanism that is adjustable to accommodate different feed loadings.

Another object of the disclosure is to provide a feed shelf adjuster mechanism that is adjustable to accommodate different operator requirements.

Another object of the disclosure is to provide a feed shelf adjuster mechanism that is retrofittable to prior feeder mechanism solutions.

Another object of the disclosure is better control of feed shelf position.

Another object of the disclosure is to provide feed shelf positioning nomenclature that is permanent.

Another object of the disclosure is to eliminate feed packing behind or in the feed shelf adjuster and components.

Another object of the disclosure is to prevent feed waste and loss between feeder components.

Another object of the disclosure is to minimize fastening hardware.

Another object of the disclosure is to better utilize design elements to improve force transfer from feed shelf to shelf adjuster mechanism.

Another object of the disclosure is automation of production with robotic MIG weld.

Another object of the disclosure is automation of production with robotic spot weld.

Another object of the disclosure is to provide a feeder shipped ready to install.

Another object of the disclosure is to provide a feeder that can be a dry feeder only.

Another object of the disclosure is to provide a feeder that can be a wet dry feeder.

Another object of the disclosure is to provide a water system that can be easily removed for service.

Another object of the disclosure is to provide a feeder shelf with appropriate rattle to stimulate hog rutting.

Another object of the disclosure is to minimize the material thickness.

Another object of the disclosure is increase strength of components by engineering proper load transfer.

These and other undisclosed objects, features, or advantages of the disclosure will become apparent from the specification, figures and claims.

### BRIEF SUMMARY OF THE DISCLOSURE

The disclosure relates to a feeding system for providing feed and water to livestock. The disclosure relates to an livestock feeding system with smooth surfaces for preventing animal injury. The disclosure relates to a robust livestock feeding system that withstands repeated animal contacts. The disclosure relates to an improved livestock feeding system that stimulates a hog's natural rooting instinct. The disclosure relates to an improved livestock feeding system that provides individual feeding areas to prevent conflict between animals during feeding.

### BRIEF DESCRIPTION OF THE DRAWINGS

FIG. 1 depicts a feeder assembly and general sub-assembly components according to one embodiment.

FIGS. 2A and 2B depict a feeder tank formed by end and side panels according to one embodiment.

FIG. 3 depicts a joint formed by longitudinally extending double folded safety edges of the end and side panel according to one embodiment.

FIG. 4 depicts a feed pan sub assembly according to one embodiment.

FIG. 5 depicts divider panel design elements according to one embodiment.

FIG. 6 depicts a divider panel interlock with feed pan.

FIGS. 7A and 7B depict a feeder weldment according to one embodiment.

FIG. 8 depicts a shelf profile and side view of feeder shelf assembly components according to one embodiment.

FIG. 9 depicts a section view of feeder shelf according to one embodiment.

FIG. 10 depicts a side view of feeder shelf according to one embodiment.

FIG. 11 depicts a cross section view of self-seal and components according to one embodiment.

FIG. 12 depicts a cross section view of shelf lift bar supporting forces according to one embodiment.

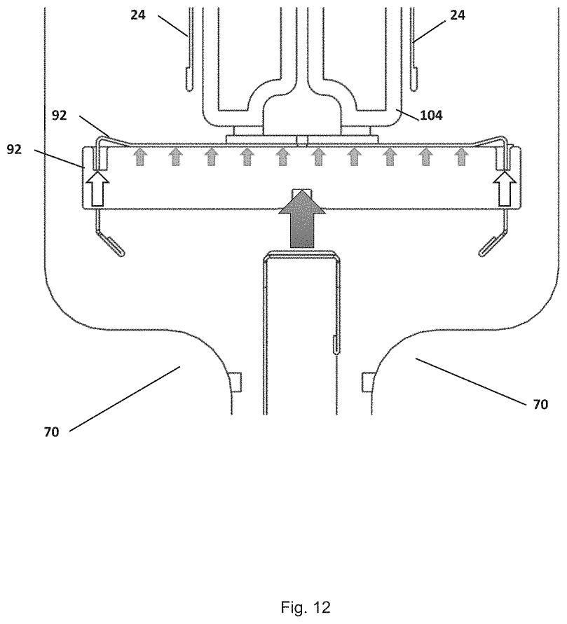

FIG. 13 depicts a cross section view of feeder normal to end panel according to one embodiment.

FIG. 14 depicts a feed shelf adjusting mechanism with the end panel removed according to one embodiment.

FIG. 15 depicts a feed shelf adjusting mechanism with the side panel removed according to one embodiment.

FIG. 16 depicts an outer click plate according to one embodiment.

FIG. 17 depicts an inner click plate according to one embodiment.

FIG. 18 depicts a cross section view of an inner and outer click plate assembly according to one embodiment.

FIGS. 19A, 19B, and 19C depict components of a feed shelf adjusting mechanism according to one embodiment.

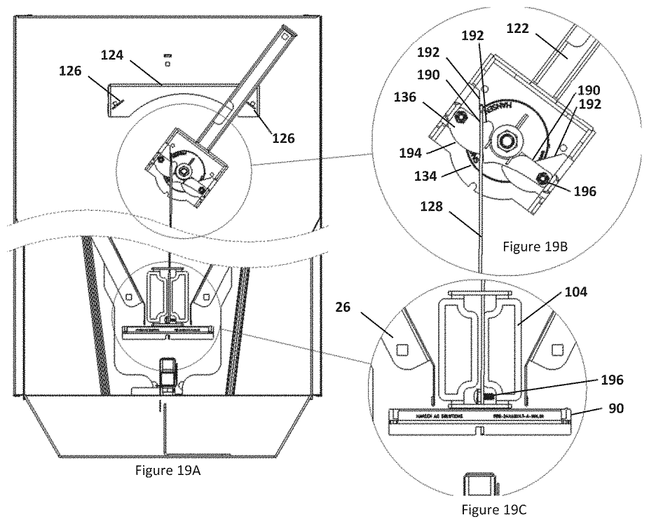

FIG. 20 depicts an exploded view of a handle and pendulum lock key according to one embodiment.

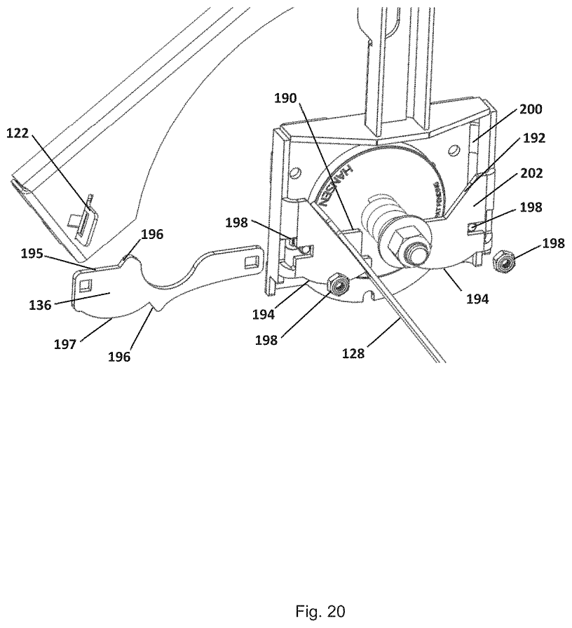

FIGS. 21A and 21B depict a feed shelf adjusting mechanism in a closed position according to one embodiment.

FIGS. 22A and 22B depict a feed shelf adjusting mechanism in an open position according to one embodiment.

FIG. 23 depicts feed shelf adjusting mechanism components according to one embodiment.

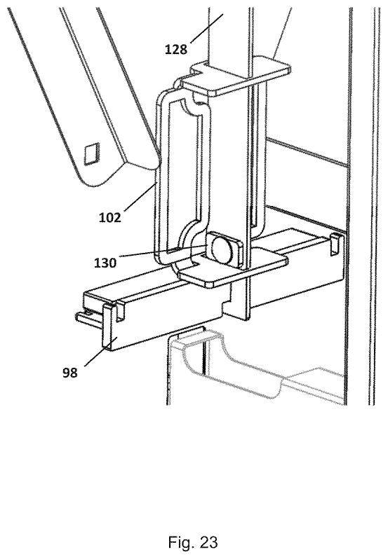

FIG. 24 depicts a feeder water supply according to one embodiment.

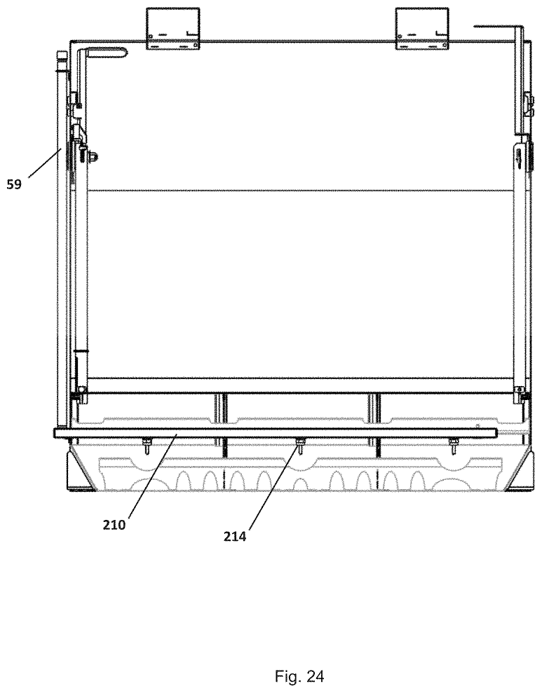

FIG. 25 depicts a feed tube locator accessory according to one embodiment.

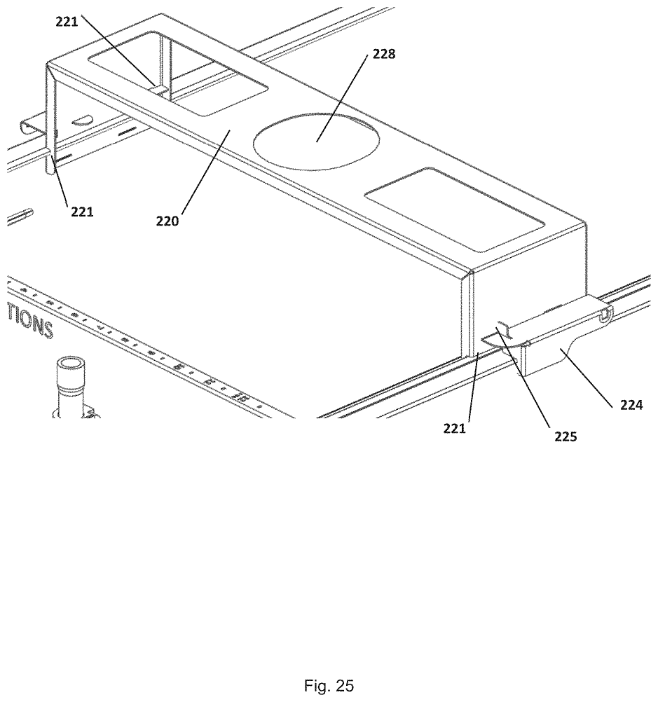

FIG. 26 depicts a motorized feed adjustment according to one embodiment.

### DETAILED DESCRIPTION

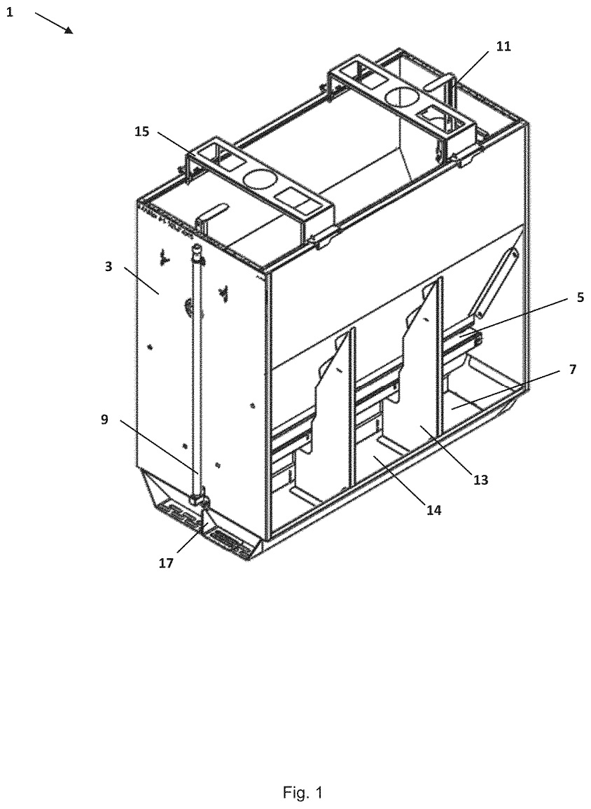

As shown in FIG. 1, an animal feeder 1 has at least one: feed tank or reservoir assembly 3; adjustable feed shelf assembly 5; feed-pan assembly 7; water supply line assembly 9; feed shelf adjuster mechanism assembly 11; divider panel 13; feed stall 14; feed supply line tube positioning assembly 15; and blocker plate 17. Each of these assembly or items will be further disclosed. The structure of the animal feeder 1 disclosed herein advances the animal well-being performance characteristics of the at least one animal feeder 1. This structure of the animal feeder 1 disclosed herein advances the animal feeder's 1 structural performance.

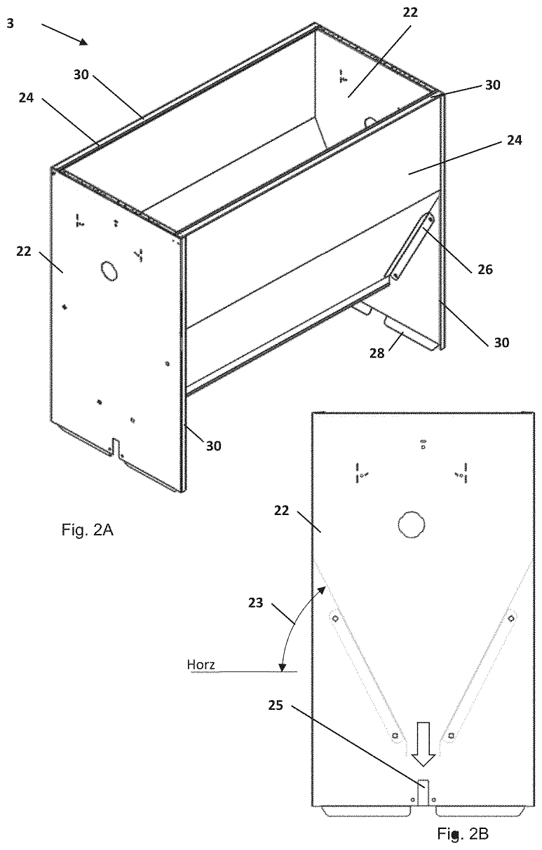

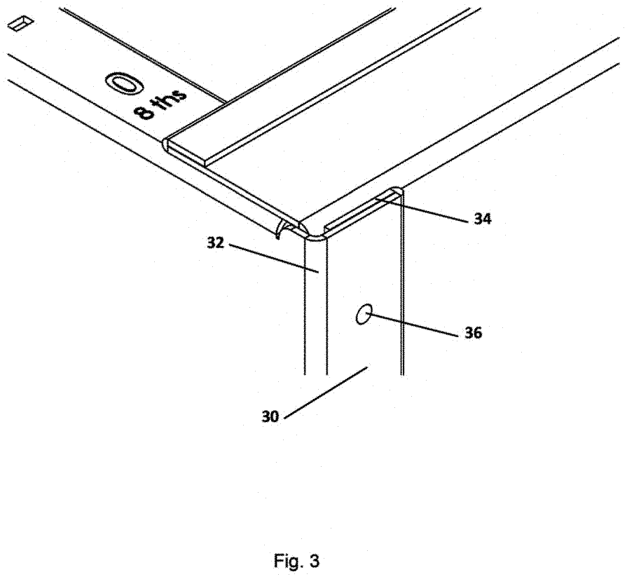

As shown in FIGS. 2A and 2B, the at least one feed tank or reservoir assembly 3 is primarily defined by at least one end panel 22 and at least one side panel 24. Throughout this disclosure, the feed tank or reservoir assembly 3 may also be referred to interchangeably as the feed tank/reservoir assembly 3 or the feed tank reservoir 3. Side panel 22 may comprise a flat generally rectangular surface, or side panel 22 may feature at least generally horizontal one bend such that side panels 22 mounted opposite and parallel to each other form a void within the feed tank reservoir 3 that is angled inwardly toward the bottom of the feed tank reservoir 3. End panel 22 and side panel 24 may be formed from sheet metal or any other suitable material. At least a portion of at least one edge of end panel 22 contacts or connects at or near at least one edge of side panel 24. In one embodiment, animal feeder 1 comprises first and second end panels 22 and first and second side panels 24 wherein each end panel 22 and side panel 24 has first and second edges and wherein at least a portion of the second edge of the first side panel 24 contacts or connects at or near the first edge of the first end panel 22, at least a portion of the second edge of the first end panel 22 contacts or connects at or near the first edge of the second side panel 24, at least a portion of the second edge of the second side panel 24 contacts or connects at or near the first edge of the second end panel 22, and at least a portion of the second edge of the second end panel 22 contacts or connects at or near the first edge of the first side panel 24 such that the assembly formed by the end panels 22 and the side panels 24 is capable of holding animal feed or a similar substance. The at least one end panel 22 and side panel 24 are each formed with at least one longitudinally extending double folded safety edge 30. As shown in FIG. 3, a longitudinally extending double folded safety edge 30 consists of at least one bend 32 and safety hem 34 forming a longitudinally extending structure providing strength and a continuously smooth surface at all points of animal contact. Bend 32 is formed by bending an edge of end panel 22 or side panel 24 to form a 1 to 179 degree bend in the material of end panel 22 or side panel 24. A safety hem 34 is formed by folding sheet metal 180 degrees about a minimal radius, thus placing the pre-bent common material surfaces in contact. The at least one end panel 22 has the at least one longitudinally extending double folded safety edge 30 which extends from the top of the feed tank reservoir 3 to top of the feed-pan assembly 7. As shown in FIG. 2B, a portion of the at least one side panel 24 is bent at an angle of repose 23 to ensure granular feed flow through the feed exit 25. In one embodiment the feed exit 25 comprises at least one rectangular opening through which feed can exit the feed tank reservoir 3. The at least one side panel 24 is mounted such that its edges are parallel to the edges of the at least one end panel 22 and its broad surfaces are perpendicular to the broad surface of the at least one end panel 22. When two side panels 24 and two end panels 22 are used to form the feed tank reservoir 3, the side panels 24 are mounted such that their edges are parallel to the edges of the end panels 22, the broad surfaces of the side panels 24 are perpendicular to the broad surfaces of the end panels 22, first and second side panels 24 are mounted opposing each other, and first and second end panels 22 are mounted opposing each other. The at least one longitudinally extending double folded safety edges 30 of end panel 22 and side panel 24 join at their respective ends forming an approximately 90-degree corner at the top of the feeder 1. The intersection of multiple longitudinally extending double folded safety edges 30, when spot and MIG welded provides maximum corner strength and a smooth safety corner at all locations of animal contact. In addition to strength, the double folded edge 30 provides an interlocking nested structure between the at least one end panel 22 and the at least one side panel 24, that supports spot welding 36, MIG welding, adhesives, or any combination of known and robust manufacturing processes. As disclosed, spot welding 36 is a durable, automated, repeatable, and proven manufacturing process that can be performed using robotic welders. The at least one side panel 24 costs are controlled by having no features, such as holes, slots or tabs that require secondary manufacturing costs, such as punching or laser cutting. Therefore, all components, assemblies and parts connected to the at least one side panel 24 must be welded, bonded, or clamped to. In one embodiment, the at least one side panel 24 is blanked and press braked. The at least one longitudinally extending double folded safety edge 30 on the end panel 22 is extremely important for engineered strength requirements, far surpassing the strength of simple hemmed or rolled edges. Furthermore, the safety hem 34 of the at least one longitudinally extending double folded safety edge 30 positions the side panel 24 the correct offset to avoid the end surface of the side panel 24 from contacting the radius of the inside bend of the end panel's 22 bend radius of the at least one 90-degree bend 32. By not contacting the radius, the potential for gaps between the end panel 22 and side panel 24 is avoided, and such a potential for feed loss is prevented. This offset allows normal opposing compression on the end panels 24 to ensure a tight fit between the side panels 24 during welding and prevents gapping and feed loss. Without a tight fit, some feeds, especially highly ground feeds can leak. In some instances, feed leakage can result in a significant investment loss and lower calories to protein conversion.

The at least one longitudinally extending double folded safety edge 30 consists of at least one 1- to 179-degree bend 32 and safety hem 34 that form a plurality of longitudinally extending bent forms providing strength and continuously smooth surface at all points of animal contact. In one embodiment, safety hem 34 is defined as folding sheet metal approximately 180 degrees about a minimal radius, thus placing the pre-bent common material surfaces generally in contact. In another embodiment, safety hem 34 is formed by a triple folded safety edge comprising a first 1- to 179-degree bend 32 about a minimal radius and a second 1- to 179-degree bend 32 about a minimal radius placing the three layers of pre-bent common material surfaces generally in contact. In other embodiments the safety hem 34 could include an open, teardrop, or rolled geometry.

The at least one end panel 22 has at least one cutout feature to allow for the mounting of the at least one water supply line assembly 9; feed shelf adjuster mechanism assembly 11; and other accessories. Each of these assembly requirements will be later disclosed. The end panel 22 can additionally or alternatively have other features for attaching components related to the feeder 1, gating, feed systems, water systems, or any other production equipment and technology necessary for animal production. All components of the at least one feed tank reservoir 3 may be constructed from stainless steel, but could be constructed from any material that provides the required mechanical structure, resistance to corrosion, and animal well-being that are needed for confined or exterior fed animal production.

In one embodiment, each side panel 24 is connected to at least one adjacent end panel 22 with at least one 90-degree strap 26. Strap 26 may comprise a length of angle iron or another elongated piece of material having a first flat surface and a second flat surface wherein the first flat surface and second flat surface are perpendicular to each other. The at least one 90-degree strap 26 is attached to side panel 24 such that a first flat surface of strap 26 is securely fastened to a surface of side panel 24, and the second flat surface of strap 26 is securely fastened to a surface of end panel 22. Strap 26 may be attached to side panel 24 and end panel 22 by spot welding or other suitable attachment method. All the ends of the longitudinally extending double folded safety edge 30 may be MIG welded to increase strength and smooth joints to meet animal well-being requirements. Weld points are indicated by the identifiers W1 and W2 where W1 identifies locations where spot welding is used and W2 identifies locations where MIG welding is used.

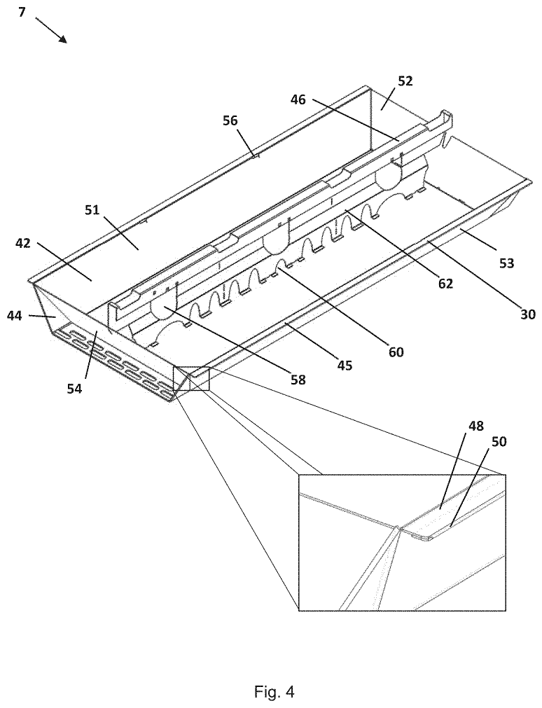

As shown in FIG. 4, the at least one side panel 24 is connected to at least one end of feed-pan assembly 7. The end panel 22 comprises at least one end panel tab 28 formed by partially folding a lower portion of the end panel 22 inward such that the fold that forms end panel tab 28 is parallel to the interior surface of the feed pan assembly 7. End panel tab 28 may be spot welded as indicated by W1, or may alternatively be welded, clinched locked, bolted, or bonded, or otherwise connected with standard metal fabrication techniques.

The feed pan assembly 7 consists of at least one: feed pan 42; foot-plate 44; and horizontal divider plate 46. Like the at least one side panel 24 and end panel 22, the feed-pan outer edges 45 utilize a longitudinally extending double folded safety edge 30 to provide strength. In this instance, the bend is an approximately 60-degree bend 48 and a safety hem 50. Although, the angle differs between the at least one feed-pan 42, end panel 22, and side panel 24; the engineering intent is the same, increased strength and animal well-being. The feed pan's 42 longitudinally extending double folded safety edge 30 is welded to the at least one longitudinally extending double folded safety edge 30 of the at least one end panel 22.

The at least one feed-pan 42 may be constructed from a single sheet of metal or other suitable material. The tapered walls 51, 52, 53, and 54 are bent maximizing the ratio of bent edges versus welded corner joints. To further strengthen the at least one feed-pan 42, the at least one foot-plate 44 is structurally integrated into the feed-pan's welded corners. The at least one feed-pan's 42 tapered walls 52 and 54 allow recessing the at least one foot-plate 44 within the at least one feed tank reservoir's 3 perimeter footprint. In addition to structural advantages, use of an integrated foot-plate 44 eliminates the need to ship loose parts, reduces installation time, and allows tighter positioning of gating structures.

The at least one feed-pan 42 includes at least one longitudinally extending double folded safety edge interlock slot 56 to receive the at least one longitudinally extending double folded safety edge 30 of divider panels 70. This assembly method increases the strength of the divider panels 70 significantly.

The feed-pan assembly 7 and the of at least one horizontal divider plate 46 are welded at contact points as required. The horizontal divider plate 46 utilizes bends and safety hems for structure and animal well-being. The horizontal divider plate 46 includes reliefs, cuts, and structures to mount the water supply system, allow bi-side access to the water nipples 214, provide wash out 60 reliefs for cleaning the feeder 1, and prevent small animals (such as piglets) from moving between pens 62.

All components of the at least one feed tank reservoir 3 may be formed from stainless steel, but any other material that provides for the mechanical structure, resistance to corrosion, and animal well-being requirements for confined or exterior fed animal production may be used without departing from the scope of the disclosure.

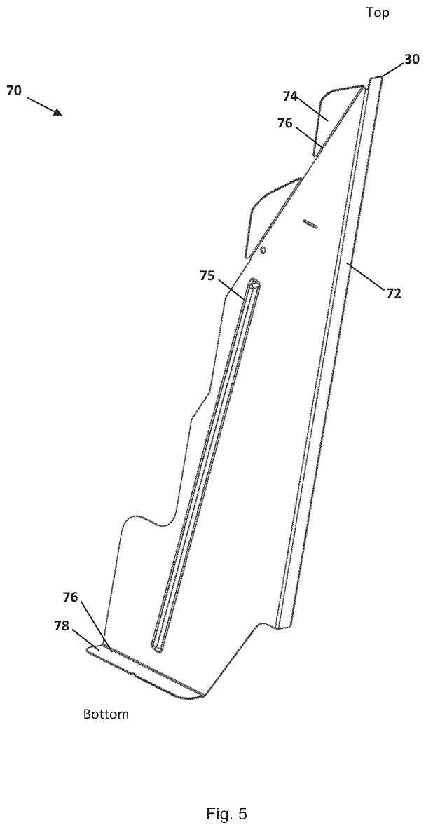

As shown in FIG. 5, at least one divider panel 70 is used to separate feeding animals in adjacent feed stalls 14. Without separation, animals are known to fight, resulting in injury or death of one or both animals. Due to its physical location and function, the at least one divider 70 is exposed to animal bumping, leaning, scratching, rubbing, and chewing on the divider panel front edge 72. A feeder can experience up to 600 animal feeding interactions daily with a broad distribution of contact events, ranging from minor to severe. To structurally withstand these events, the at least one divider panel 70 utilizes at least one: longitudinally extending double folded safety edge 30 on the front edge 72; top edge tab 74, bottom edge tab 78 and a formed or stamped geometry on near or on the rear edge 75. The bent edges 76 of tabs 74 and 78 increase the stiffness of both the top and bottom edges when spot welded to the at least one side panel 24 and the at least one feed-pan 42.

The at least one divider panel 70 and the at least one tab 74 are generally planar to at least one side panel 24 and joined with at least one spot weld W1. The at least one divider panel 70 and at least one tab 78 are generally planar to at least one feed-pan 42, respectively and joined with at least one spot weld W1. The bottom of the divider panel 70 features a longitudinally extending double folded safety edge 30 that is inserted into the longitudinally extending double folded safety edge interlock slot 56 of the feed-pan 42 and MIG welded at location W2. The top edge of the longitudinally extending double folded safety edge 30 is MIG welded at welding location W2 to at least one side panel 24. The remainder of tabs 78 are spot welded W1, welded, clinched locked, bolted bonded, or otherwise attached with standard metal fabrication techniques. A final connection of the at least one divider panel 70 and the at least one horizontal divider plate 46 is completed with at least one connector tab 82. The at least one connector tab 82 is interlocked to the at least one horizontal divider plate 46 using at least one slot lock tab 84. The at least one slot lock tab 84 has at least one tab that interlocks with a precut slot on the at least one horizontal divider plate 46. The at least one connector tab 82 is secured to the at one divider panel 70 in this disclosure using spot welding.

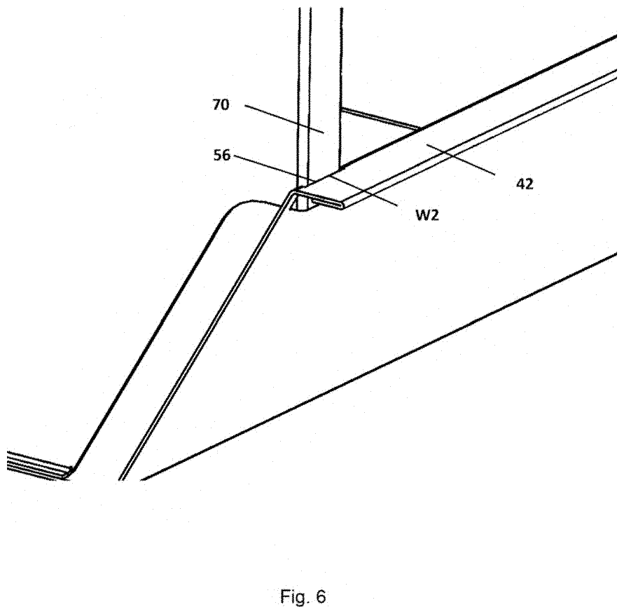

As shown in FIG. 6, greater detail is illustrated of the very important engineered structural gain achieved by the at least one divider panel 70 and one interlocking longitudinally extending double folded safety edge 30 and the longitudinally extending double folded safety edge interlock slot 56 located in the feed-pan 42.

The at least one divider panel 70 may be formed from stainless steel or any material that provides for the mechanical structure, resistance to corrosion and animal well-being requirements for confined or exterior fed animal production.

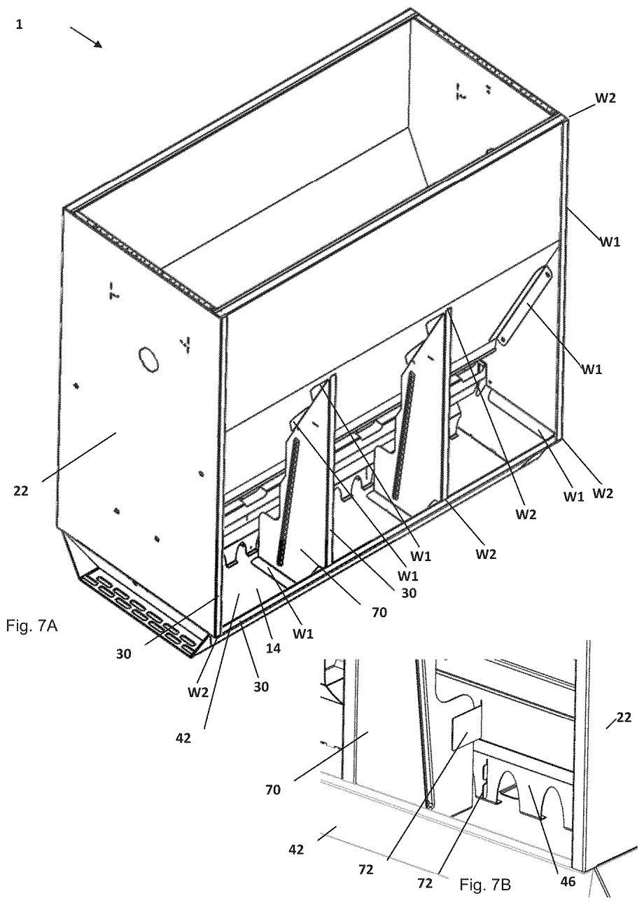

As shown in FIGS. 7A and 7B, the at least one a feed stall 14 is fully constrained by the at least one end panel 22, feed-pan 42 and divider panel 70 where longitudinally extending double folded safety edges 30 form all contact edges. The disclosed system of formed, interlocking longitudinally extending double folded safety edges 30 fastened by spot welding W1 and MIG welding W2 defines the most robust feed stall 14 supporting animal well-being and feeder durability requirements.

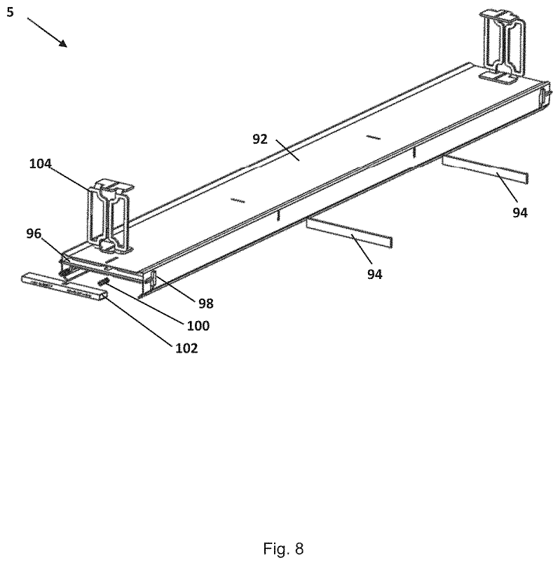

As shown in FIG. 8, the at least one feed shelf assembly 5 is vertically adjustable by a feed shelf adjuster mechanism assembly 11. The shelf assembly 5 must structurally support the feed in the at least one feed tank reservoir 3 and any incidental load applied by the animal during feeding, such as stepping on the edge of shelf 92. In addition to structural strength and well-being, the feed shelf 92 is engineered to contain the feed above the shelf 92 without leakage. Leakage is defined as a state where feed is not constrained to the shelf 92 and continuously flows of into the feed-pan 42, or worse into the bio-waste containment pit located below the floor on which the feeder 1 is situated. Furthermore, finely ground feed will continuously leak without proper sealing between the at least one feed shelf 92 end and the at least one feed tank reservoir 3 and end panel 22. The components of the feed shelf assembly 5 include at least one: feed shelf 92, cross bar 94, seal shelf plate 96, lift bar 98, seal spring 100, seal 102 and rattle plate 104.

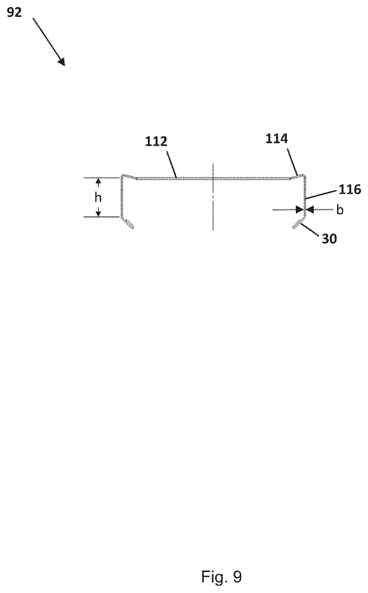

As shown in FIG. 9, a profile view of the at least one feed shelf 92 reveals the at least one planar feed surface 112, at least one feed stop 114 and at least one vertical shelf beam 116. The at least one feed stop 114 is bent the longitudinal length of the at least one feed shelf 92 and mirrored about the feed shelf 92 centerline and at an angle sufficient to restrict feed from sliding over the edge of feed shelf 92. The feed stop 114 is generally parallel to and laterally positioned approximately 1-inch from the bottom edge of the at least one side panel 24, see FIG. 9. The feed remains on the shelf 92 until an animal eats or causes feed to fall into the feed-pan 42.

The at least one feed shelf assembly 5 is not a rigid structure. When used in hog confinements, the natural rooting of the hog rattles the feed shelf assembly 5 vertically and horizontally, causing food to become dislodged into the feed-pan 42. The at least one feed shelf 92 has at least one vertical beam 116 and at least one longitudinally extending double folded safety edge 30 which is mirrored about a mid-plane.

The at least one vertical shelf beam 116 is extremely important to transferring the shelf 92 loading to the feed shelf adjuster mechanism assembly 11, thus eliminating a common failure point of other feeders. The at least one vertical shelf beam 116 structurally performs like a common floor truss. The vertical shelf beam 116 ends are simply supported and the shelf 92 load carrying capacity across the span is increased due to the depth of the vertical section, i.e., 1=(bh\hat{ }3)/12, where h is the height of the vertical shelf beam 116 and b is the thickness of the sheet metal or other material used to construct the shelf 92. Increasing the height of the vertical shelf beam 116 increases the span, reduces deflection and minimizes material required.

The at least one feed shelf 92 is structurally reinforced within the area bounded or boxed in by the planar feed surface 112, feed stops 114, and vertical shelf beams 116 using at least one cross bar 94. One or more cross bars may comprise generally rectangular pieces of sheet metal or other suitable material connected to the vertical shelf beam 116 and feed shelf 92. The at least one cross bar 94 is MIG weld to the vertical shelf beam 116 and the feed shelf 92 reducing deformation due to outward deflection of the vertical shelf beam 116.

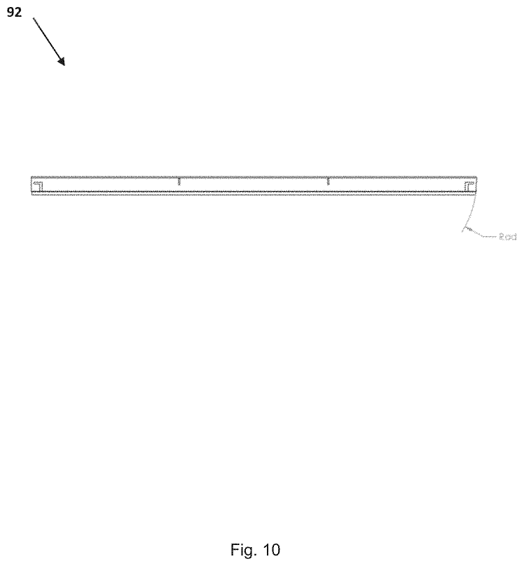

The at least one feed shelf 92 when used with the at least one adjustment mechanism 11 can rotate about each point where the feed shelf 92 connects or contacts the adjustment mechanism 11. In extreme positions this non-planar position causes the ends of the vertical shelf beam 116 to contact with the end panel 22. Contact with the end panel 22 can cause binding, lodging, damage to shelf 92 or end panel 22 or both shelf 92 and end panel 22. Therefore, as shown in FIG. 10, an arc Rad relief cut of a radius less than the length of the feed shelf 92 is applied into the at least one feed shelf 92 end eliminating the cause of binding. The arc could be replaced with other geometries, such as angular, ellipse, or rectangular reliefs.

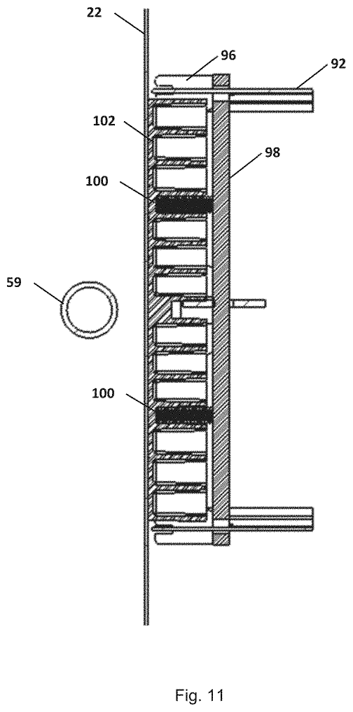

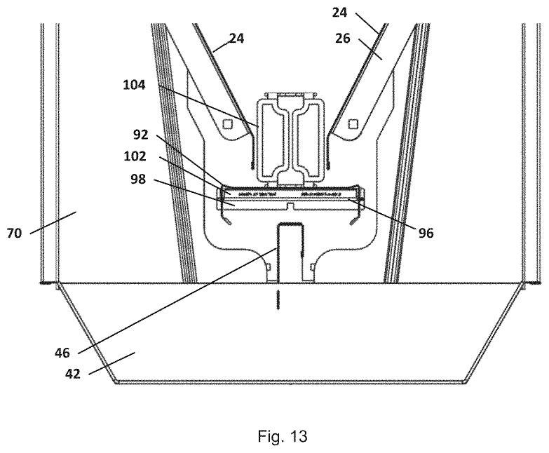

As shown in FIG. 11, to prevent feed leakage between the at least one feed shelf 92 and the at least one end panel 22, at least one seal 102 is mechanically compressed by at least one spring 100 against the at least one end panel 22. The spring 100, by example, is constrained in at least one generally cylindrical pocket located in the at least one seal 102 and applies an equal and opposite force to seal 100 and the lift bar 98. The seal 102 is bounded in at least one generally rectangular pocket formed by the at least one vertical shelf beam 116, the at least one feed shelf 92 and the at least one seal shelf plate 96. In one embodiment, the at least one seal 102 may be a moldable plastic, poly, synthetic material, metallic material, or other suitable material with a low coefficient of friction and high wear characteristics. Furthermore, all components constraining the at least one seal 102 are interlocked, thus allowing the at least one feed shelf assembly 5 to shift and rattle when the animal engages with the feeder. As shown in FIGS. 8 and 13, at least one rattle plate 104 rests on the at least one feed shelf 92. The at least one rattle plate 104 allows the feed shelf 92 to slightly rock back and forth between at least one side panel 24. The at least one rattle plate 104 captures at least one pendulum lift strap 128.

In one embodiment, all components of the at least one feed shelf assembly 5 excluding the seal 102 may be stainless steel or any other material that meets the mechanical structure, resistance to corrosion and animal well-being requirements of confined or exterior fed animal production.

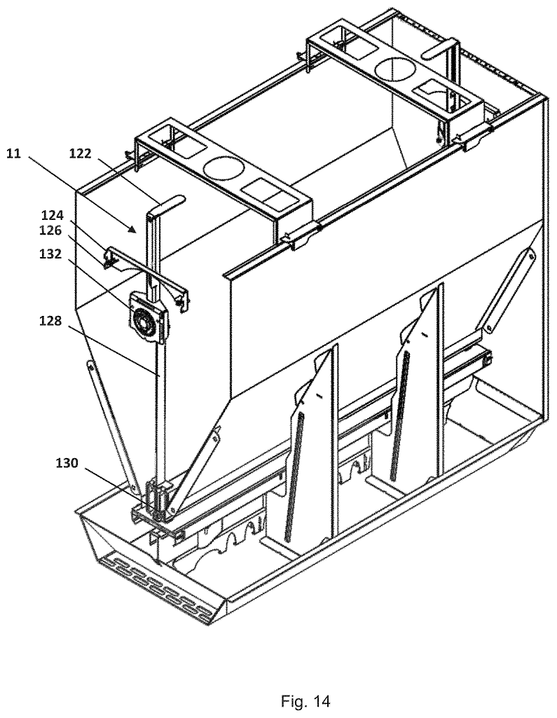

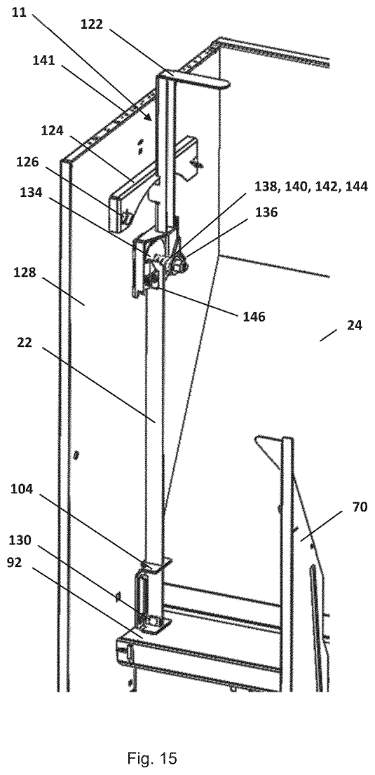

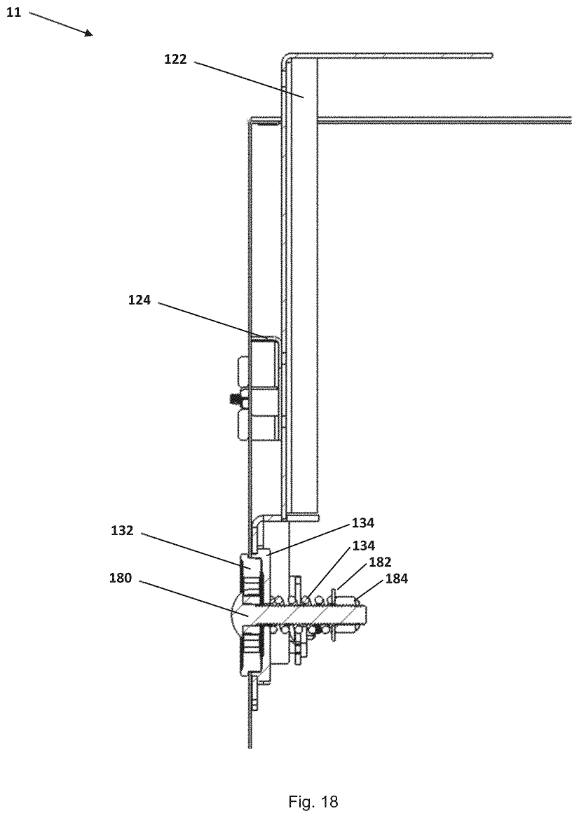

As shown in FIGS. 14-18, the feed shelf adjuster mechanism assembly 11 comprises at least one outer click plate 132; inner click plate 134; handle 122, handle brace 124, pendulum lift strap 128, pendulum locking key 136, click plate spring 136 and bolt and nut hardware. The feeder mechanism must be easily adjusted by facility staff and once adjusted stay in that position. Failure to remain in position results in under or over feeding the animals.

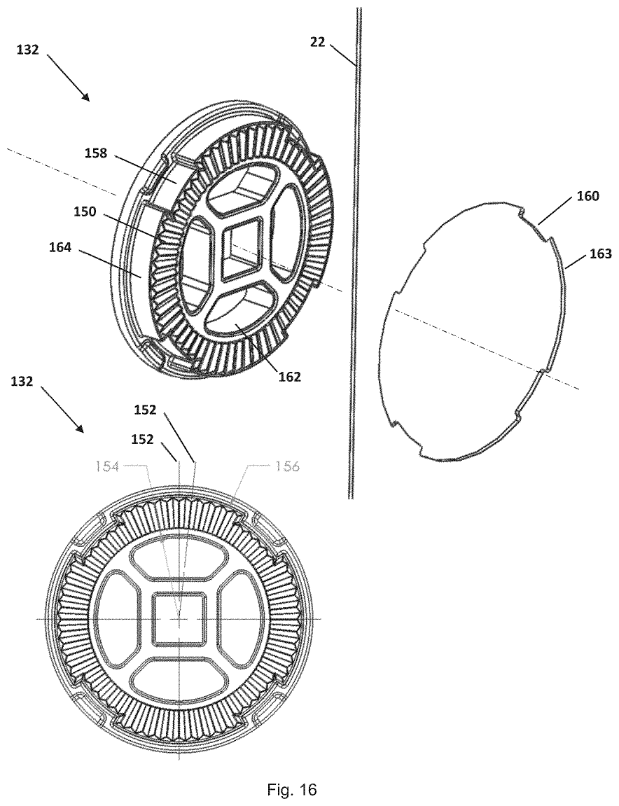

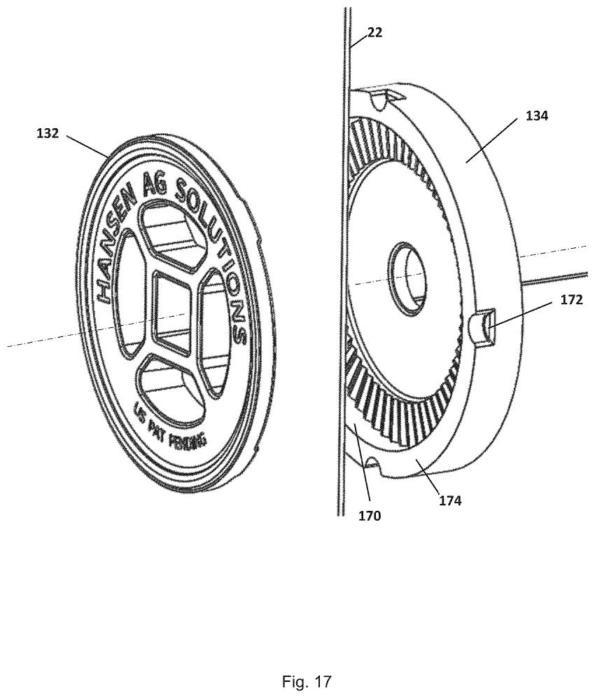

As shown in FIGS. 16 and 17, the foundation of the feeder 1 is the feed adjustment system comprising at least one outer click plate 132 and inner click plate 134. The at least one outer click plate 132 has at least one tooth 150 radially extending from an inner to outer surface. The at least one tooth's 150 top surface is positioned on a on a planar surface parallel to the end panel 22. The tooth 150 shape is defined on the planar surface by two radial lines 152 extending from the centerline at an arc angle equal 2π/number of teeth 150. The tooth 150 is radially bounded by the inner relief 154 and outer relief 156. The planar shape is extruded at a draft angle until the planes extending through the two radial lines intersect. The tooth 150 root depth is a function of the distance from for the axis of rotation, with the tooth 150 depth increasing with larger radius.

The at least one tooth 150 is rotationally patterned at least one time about the center axis to create a radial tooth 150 pattern. The number of teeth 150 determines the increment at which the feed shelf 92 can be adjusted. The disclosed feeder 1 adjustment system's minimum angular adjustment is 6-degrees, 60 teeth 150, which number can be increased or decreased per feeding requirements. The at least one outer click plate 132 is engineered to contact the outer surface of the end panel 22 and be angularly constrained to the end panel by at least one radial slot 158 and at least one click plate radial tab 160 located about the handle 122 axis of rotation in the end panel 22. The at least one outer click plate 132 has a cylindrical bearing surface 164 revolved about the central axis of rotation. The at least one outer click plate 132 cylindrical bearing surface 164 positions the outer click plate 132 cylindrically to the end panel journal 163 and provides a bearing surface for the inner click plate 134 to rotate about the handle 122 axis of rotation. The cylindrical surface 164 must be free to slide normal to the end panel 22 within the constraining end panel journal 163 and radial tab 160. Moving the at least one handle 122 causes the at least one click plate spring 136 to compress due to teeth 150 moving up contacting teeth 150 surfaces, then relocking, incrementing the feed shelf 92 position.

As shown in FIG. 17, the at least one inner click plate 134 is mounted opposing an outer click plate 132 on the opposing plane of the at least one end panel 22; rotating about a common axis of the at least one outer click plate 132; and connecting to the at least one handle 122. The inner click plate 134 utilizes the same tooth 150 geometry and construction as described previously for the outer click plate 132. The inner click plate 134 has an inner cylindrical surface 170 that locates and rotates about the outer click plate cylindrical surface 164. The at least one inner click plate 134 has at least one handle slot 172 located on the outer cylindrical geometry of the inner click plate 134. The depth of the handle slots 172 must be sufficient for the handle 122 interlocking tabs to rest below the seal face 174. The seal face 174 is planar to the end panel 22 and does not contact the end panel 22 inner surface when fully assembled and the teeth 150 seated and interlocked. This engineered design allows the at least one handle 122, outer click plate 132, and inner click plate 134 to be installed with a single compressing system. In one embodiment, that compressive system consists of a bolt 180, click plate spring 136, washer 182 and nut 184. When the shelf 92 is indexed from one position to the next, the click plate spring 138 compresses between the inner click plate 132 and the washer 182 as the teeth 150 slide up against the mating teeth 150 planar contact surfaces. During the movement from one tooth 150 increment to another, the at least one click plate spring 136 will compress and one or both of the click plates 132, 134 will move away from the end panel 22 surfaces. After crowning the top of the teeth 150, the click plates 132, 134 will slide on the contact surfaces and lock into the new index position with an audible click sound, i.e., click plates 132, 134. Besides the visual position of the handle 122, an operator knows from the sound that the adjustment has been completed. The operator also has lasered shelf position numbers 141 located on the upper surface of the at least one longitudinally extending double folded safety edge 30 of the end panel 22, specifically located at or near the top of the feed tank 3.

The adjustment of the feed shelf assembly 5 requires only the operator to push or pull on the handle 122 to move the feed shelf assembly 5. In one embodiment, the shelf adjusting mechanism 11 is mounted in a left- or right-handed orientation. The location of the at least one end panel journal 163 on the same side of the central plane, parallel to the side panel 24 allows common handle 122 motion, either pulling or pushing to move the feed shelf assembly 5 up or down. This function requires either the handle 122 to have a left- and right-handed configuration or a bi-directional handle 122.

The at least one inner click plate 134 and outer click plate 132 assembly is self-cleaning. In the event feed enters the click plates 132, 134 between the at least one inner click plate 134 seal surface 174 and the interior surface of at least one end panel 22, it will be ground between the teeth; exit into the interior space of the click plate assembly; and ultimately exit through the at least one vent hole 162 located in the at least one outer click plate 132.

Alternative tooth geometries could be utilized to provide discrete feed shelf assembly 5 positioning.

In one embodiment, the at least one outer click plate 132 and inner click plate 134 are hardenable stainless steel material. Alternatively, the click plates 132 and 134 may be constructed from injectable plastics, polymers, or synthetics that provide the mechanical structure, resistance to corrosion and animal well-being requirements for confined or exterior fed animal production. Furthermore, in one embodiment the at least one outer 132 and inner click plate 134 are manufactured using powdered metal casting and sintering process for high repeatability and required production rates. Other manufacturing methods may be used to yield the same performance capabilities without departing from the scope of the disclosure.

The at least one handle 122 is planar constrained between the at least one inner click plate 134, at least one end panel 22; and radially constrained to the at least one handle slot 172. The at least one handle 122 is formed with the at least one bend 200, in a sheet metal fabricated design as disclosed, the at least one lift tab 202 parallel to the end panel 22. The at least one lift tab 202 is disclosed as oriented towards the centerline of rotation. The at least one lift tab 202 can be oriented in any other angular reference to provide the required connection to a lifting strap, rod, cable, or other connecting element between two elements. The at least one lift tab 202 has a pendulum lift strap pivot surface 190 radially positioned about the handle 122 assembly's axis of rotation. The radial position of the at least one lift tab 202 is a function of degrees of handle 122 adjustment and the maximum feed shelf 92 opening requirements. The total handle 122 degrees of movement define the arc length of the pendulum lift strap arc 194 and the at least one pendulum lift strap locking key arc 197. The at least one lift tab 202 parallel is mirrored about the axis of rotation, creating a functional handle 122 for clockwise- and counter-clockwise rotation applications, as shown by example. Similarly, the at least one pendulum locking key 136 has a pendulum lift strap pivot surface 190 radially positioned about the handle 122 assembly's axis of rotation and pendulum lift strap arc 194. The at least one pendulum lift strap upper slot 146 is coincident and free on the combined pivot surfaces of at least one pendulum lift strap pivot surface 190 and the at least one pendulum lift strap locking key pivot surface 195. The unconstrained pivot allows the at least one pendulum lift strap 128 to remaining normal to the at least one feed shelf assembly 5. The at least one lift tab 202 has a means to secure the at least one pendulum locking key 136. In one embodiment, at least two extruded elements are used in combination with at least two square holes that use fastening hardware 198, which may comprise carriage bolts and locking nuts, to fully constrain the pendulum lift strap 128 to the at least one handle assembly 122. The at least one lift tab 202 allows installation of the click plate spring 136, washer, and lock nut.

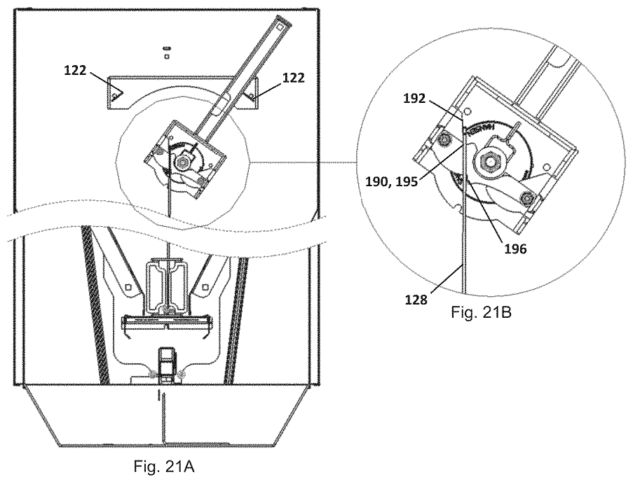

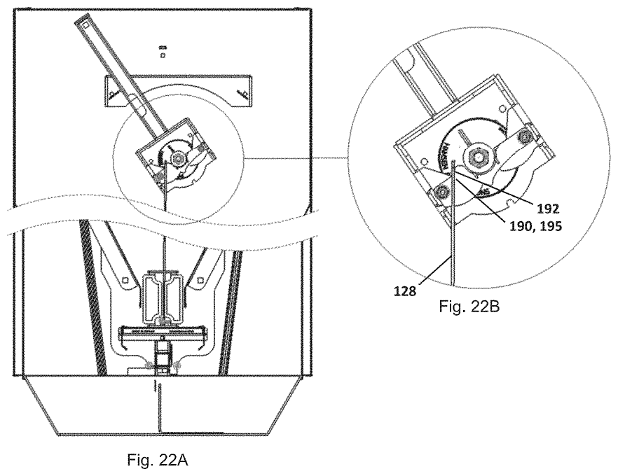

As shown in FIGS. 21A and 21B (depicting a fully closed feed shelf adjustment mechanism 11) and FIG. 22 (depicting a fully open feed shelf adjustment mechanism 11), the relationship between the at least one: pendulum lift strap 128; pendulum lift strap locking key arc 197; pendulum lift strap locking key containment surface 196; pendulum lift strap locking key pivot surface 195; pendulum lift strap arc 194; handle assembly containment surface 192; and pendulum lift strap pivot surface 190.

The at least one pendulum lift strap 128 extends through the at least one rattle plate 104, feed shelf 92, mechanically interlocks with at least one lift bar 98, secured with a pendulum lift strap retaining washer 130 and secured with commodity bolt hardware. The mechanical interlock between the at least one pendulum lift strap 128, the at least one rattle plate 104, feed shelf 92, the at least one lift bar 98 and at least one pendulum lift strap retaining washer 130 ensures the feed shelf assembly 5 can be “rattled” by the feeding animal to dislodge feed.

The at least one pendulum lift strap 128 is oriented generally perpendicular to the at least one end panel 22 to prevent “feed packing.” Feed packing can impair the adjustment accuracy, and in severe case jam movement of the opening of the at least one feed shelf assembly 5.

In one embodiment, the at least one handle assembly 122, the at least one pendulum lift strap 128, the at least one pendulum locking key 136, and assembly components and fastening hardware are constructed of stainless steel, but in other embodiments could be any material that provides the mechanical structure, resistance to corrosion and animal well-being requirements for confined or exterior fed animal production.

In one embodiment, the ends of feed shelf assembly 5 can be moved independently. The feeder 1 could be modified: 1) to maintain the shelf 92 in a planar motion by connecting the pendulum lift straps 128 to a common mechanism, 2) move the shelf 92 end independently with a common handle 122 design and moving handles 122 in opposite directions when positioned at the side of the feeders 1.

In one embodiment, the at least one handle 122 may be a welded assembly of two laser cut and press braked stainless steel parts that are MIG welded together. The at least one handle 122 may be constructed from any material which provides similar or same function, mechanical structure, resistance to corrosion and animal well-being requirements for confined or exterior fed animal production.

The feeder 1 has a water line system which is well known to the animal feeder industry. The water supply line 210 extends normal to and through the at least one end panel 22. The opposing end is support by the at least one horizontal divider plate 46. The water bar has at least one nipple 58 per feed stall 14. As disclosed, the at least one nipple 58 is shared by opposing feed stalls. The at least one water supply line 210 is connected to at least one vertical water supply line 59. The water supply from the building is then connected to the feeder 1.

The at least one feed tube positioner 220 is used to located drop tubes from a building's central supply feed system. These feed tubes drop from the ceiling and may have one or two supply tubes per feeder 1. The at least one feed tube positioner 220 constrains the feed tube in the at least one feed drop tube slot 228. The at least one feed drop tube slot 228 allows tubing to pass through vertically or at an angle. The at least one feed tube positioner 220, by example, is fabricated sheet metal with folded edges to provide structural strength. In this application with no animal contact, no requirement exists for utilizing the longitudinally extending double folded safety edge 30, as utilized throughout the feeder's 1 structural disclosure. As discussed previously, the at least one side panel 24 is blanked and fabricated using at least one longitudinally extending double folded safety edge 30. Therefore, accessories such as the at one feed tube positioner 220 must mount and secure without the used of typical fasteners. To lock onto the at least one side panel 24, the at least one feed tube positioner 220, has the at least one location slot 221 which extends from one folded edge to the opposing folded edge. The slot is parallel to the top surface of the at least one feed tube positioner 220. Parallel to the least one location slot 221 are slots that allow for the insertion of the cam lock hook 226. Once inserted, the cam lock hook 226 rotates to apply force against the inside of the feed tube positioner 220. This pressure is increased when the cam lock fulcrum 225 contact the outer surface of the at least one feed tube positioner 220. The opposing forces of the cam lock hook 226 and cam lock fulcrum 225 compress and lock the at least one feed tube positioner 220 to the at side panel 24.

The cam lock 224 is compressed using a bolt (not shown) at the other side and folded edge. The force applied by the bolt further secures the at least one feed tube positioner 220 and the at least one side panel 24. The attachment method is repeated on the opposing side.

The size of the feeder 1 can be modified to increase feed tank 3 capacity, number of feed stalls 14 and general dimensions of materials and geometry.

The feed shelf adjuster mechanism assembly 11 could be converted to be used in retrofitting other feeders with less robust designs.

The feed shelf adjuster mechanism assembly 11 could be utilized in other control applications.

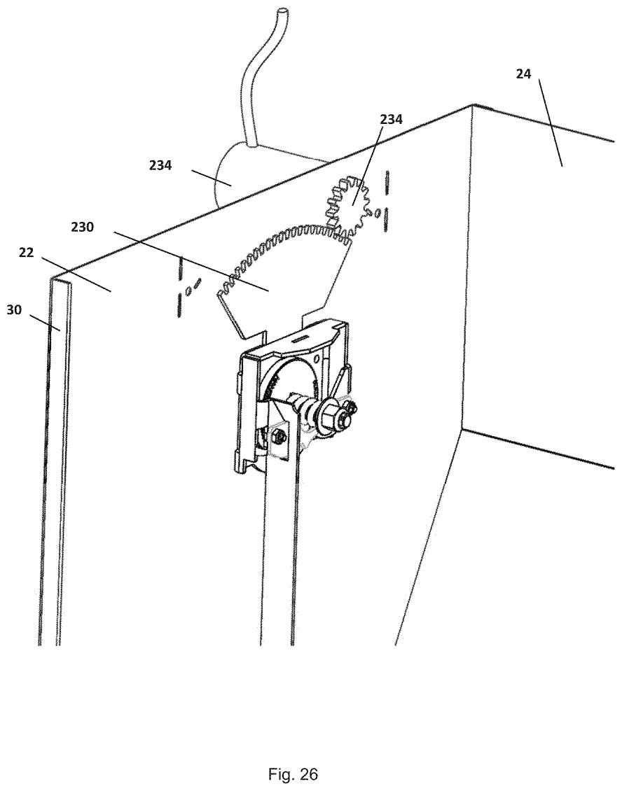

As shown in FIG. 26, the handle 122 assembly could be replaced with a driven gear 230, driving gear 232 and a motor 234 that allows for remote, or computer-controlled animal feeding.

### REFERENCE NUMERALS

1—animal feeder or feeder

3—feed tank or reservoir assembly or feed tank/reservoir assembly or feed tank reservoir or feed tank

5—adjustable feed shelf assembly or feed shelf assembly or shelf assembly

7—feed-pan assembly or pan assembly

9—water supply line assembly

11—feed shelf adjuster mechanism assembly or adjustment mechanism or feed shelf adjusting mechanism

13—divider panel

14—feed stall

15—feed supply line tube assembly

17—blocker plate

22—end panel

23—angle of repose

24—side panel

25—feed exit

26—90-degree strap or strap

28—end panel tab

30—longitudinally extending double folded safety edge or double folded edge

32—bend

34—safety hem

36—spot welding

42—feed-pan or pan box

44—foot-plate

46—horizontal divider plate

51—feed-pan wall

52—feed-pan wall

53—feed-pan wall

54—feed-pan wall

56—longitudinally extending double folded safety edge interlock slot

59—vertical water supply line

60—wash out

62—moving between pens

70—divider panel

72—divider panel front edge

74—top edge tab

75—rear edge

76—bent edge

78—bottom edge tab

82—tab

84—slot lock tab

92—feed shelf

94—cross bar

96—seal shelf plate or seal shelf

98—lift bar

100—seal spring or spring

102—seal

104—rattle plate

112—planar feed surface

114—feed stop

116—vertical shelf beam or vertical beam

122—handle

124—anti-deflection plate

126—stop tab

128—pendulum lift strap

130—pendulum lift strap retaining washer

132—outer click plate

134—inner click plate

136—pendulum locking key

138—click plate spring or spring

140—click plate nut

141—lasered scale

142—click plate washer

144—click plate bolt

146—pendulum lift strap upper slot

150—tooth

152—radial lines

154—inner relief

156—outer relief

158—radial slot

160—radial tab

162—vent hole

163—end panel journal

164—cylindrical bearing surface

170—inner cylindrical surface

172—handle slot

174—seal face

180—bolt

182—washer

184—nut

190—pendulum lift strap pivot surface

192—handle assembly containment surface

194—pendulum lift strap arc

195—pendulum lift strap locking key pivot surface

196—pendulum lift strap locking key containment surface

197—pendulum lift strap locking key arc

198—fastening hardware

200—bend

202—lift tab

214—water nipple

210—water supply line

220—feed tube positioner

221—location slot

228—feed drop tube slot

226—cam lock hook

225—cam lock fulcrum

224—cam lock

230—Gear driven

232—Gear driving

234—Motor

W1—spot weld

W2—MIG weld

What is claimed:

1. A livestock feeding system comprising:
a feed tank reservoir configured to store animal feed, the feed tank reservoir having a first end panel and a second end panel mounted parallel to each other and a first side panel and a second side panel mounted parallel to each other wherein the first and second end panels are mounted opposing each other and perpendicular to the first and second side panels and the first and second side panels are mounted opposing each other such that the first and second end panels and first and second side panels form a generally rectangular structure;
a feed shelf adjuster mounted to the at least one side panel, the feed shelf adjuster configured to regulate a feed dispensing rate;
an adjustable feed shelf mounted to the feed shelf adjuster, the feed shelf configured to meter feed from the feed tank reservoir and prevent continuous feed flow;
a feed pan mounted at a lower end of the at least one side panel, the feed pan configured to capture feed from the feed tank reservoir and allow animal access to feed and water; and
one or more dividers mounted to the at least one side panel wherein a planar surface of each divider is positioned perpendicular to a planar surface of the at least one side panel and wherein the one or more dividers create at least one feed stall, each feed stall configured to provide a safe, individual eating space for an animal to consume food or water from the feed pan or feed shelf;
wherein each of the feed tank reservoir, end panel, side panel feed shelf, feed pan, and divider comprises a plurality of edges exposed to contact by animals and wherein each said exposed edge comprises a longitudinally extending double folded safety edge.

2. The system of claim 1 wherein each longitudinally extending double folded safety edge comprises at least one bend extending the full length of each exposed edge, the at least one bend being between 1 and 179 degrees.

3. The system of claim 1 wherein the at least one end panel comprises at least one tab formed to parallel a surface of the at least one feed pan, the at least one tab welded to the at least one feed pan and the at least one tab having a generally cylindrical hole therein for mounting at least one feed shelf adjuster; wherein an outer click plate is mounted into the cylindrical hole, wherein the outer click plate is prevented from rotating by the tab.

4. The system of claim 1 wherein a lower portion of the at least one side panel is bent at an angle of repose to prevent feed bridging.

5. The system of claim 1 wherein each divider panel comprises one or more additional tabs having a bent edge configured to increase strength and rigidity.

6. The system of claim 1 wherein the feed pan comprises one or more foot plates configured to secure the feeding system to a floor.

7. The system of claim 6 wherein the one or more foot plates comprise one or more ends that are bent to be colinear with one or more corners of the feed pan.

8. The system of claim 1 wherein the feed pan is formed from a single sheet of material to maximize the ratio of formed edges to welded joints.

9. The system of claim 1 wherein the feed pan comprises one or more sides that are tapered to promote downward movement of feed.

10. The system of claim 1 wherein:
the feed shelf adjuster comprises at least one outer click plate comprising a generally cylindrical member inserted into a generally cylindrical opening disposed in the at least one end panel;
the at least one outer click plate has at least one surface radially extending past the generally cylindrical opening and planarly contacting the at least one end panel;
the at least one outer click plate has at least one tab slot that extrudes radially from the cylindrical body towards an axis of rotation;
the at least one tab slot is patterned about the axis of rotation;
the cylindrical body's planar face has at least one tooth;
the at least one tooth is incrementally patterned about the axis of rotation;
the patterned tooth pattern interlocks with the at least one inner click plate;
the inner and outer click plate are compressed together with a spring force;
a generally square hole is extruded along the axis of rotation;
the generally square hole is used to secure carriage bolt; and
an irregularly shaped hole is located between the generally square hole and the inner surface of the patterned tooth;

11. The system of claim 10 further comprising an inner click plate wherein the inner click plate comprises a generally cylindrical body which is inserted into a generally cylindrical opening disposed within at least one end panel.

12. The system of claim 11 wherein the feed shelf adjuster further comprises a handle configured to move the feed shelf.

13. The system of claim 11 wherein the feed shelf adjuster further comprises a motor configured to move the feed shelf.

14. The system of claim 11 wherein the feed shelf adjuster further comprises a pendulum strap.

15. The system of claim 11 wherein the feed shelf adjuster further comprises a pendulum strap key.

16. The system of claim 11 further comprising a lift beam.

17. The system of claim 11 further comprising a rattle plate.

18. The system of claim 11 further comprising a seal configured to prevent feed leakage.
